(19) United States
(12) Patent Application Publication
(10) Pub. No.: US 2013/0332181 A1
(43) Pub. Date: Dec. 12, 2013

(54) EVIDENCE-BASED PERSONALIZED DIABETES SELF-CARE SYSTEM AND METHOD

(71) Applicants: Gerene Delores SCHMIDT, Spokane Valley (Veradale), WA (US); Nelson Byron HAZELTINE, Chapin, SC (US)

(72) Inventors: Gerene Delores SCHMIDT, Spokane Valley (Veradale), WA (US); Nelson Byron HAZELTINE, Chapin, SC (US)

(21) Appl. No.: 13/914,032

(22) Filed: Jun. 10, 2013

Related U.S. Application Data
(60) Provisional application No. 61/658,357, filed on Jun. 11, 2012.

(51) Int. Cl. G06F 19/00

(52) U.S. Cl. CPC G06F 19/3431
USPC 705/2

(57) ABSTRACT

An evidence-based, personalized, diabetes self-care information system and method to better ensure improved personal management, outcomes and health status across time, including the steps of:
(a) Step 1 Take a measurement, for example, a Blood Glucose measurement;
(b) Step 2 Identify symptoms, for example, blurred vision;
(c) Step 3 Identify possible abnormal causes, for example, wrong dose;
(d) Step 4 Identify actual treatments, for example, Glucagon injection;
(e) Step 5 Identify actual results, for example, a blood glucose measurement closer to the normal range.

The present invention claims the benefit of previously-file provisional application Ser. No. 61/658,357, filed Jun. 11, 2012, as provided in 35 USC §119(e) and 37 CFR §1.78(a).

### BACKGROUND OF THE INVENTION

The present invention is an evidence-based, personalized, diabetes self-care information system and method to better ensure improved personal management, outcomes and health status across time. Systematic reporting, monitoring and tracking outcomes patterns include prospective planning and management to achieve personal best outcomes. Early problem identification triggers detailed data collection to analyze, prompt and guide quick action to resolve in real-time to stay on course with a prescribed health plan.

Diabetes is not a stand-alone chronic condition but a complex, chronic and progressive condition with co-existing diseases/conditions. Multiple management strategies are required to address the complexity of diabetes for different individuals and at different times of physiological and biological changes in the life span of a given individual.

Most individuals/families with diabetes manage their personal health 98% of the time, only 1 to 2% is in the healthcare delivery system of which 90% is in a busy clinic or doctor's office. The time differential spent in each environment explains the need and challenge for individuals/families to learn to become more independent to self-manage without the frequent aid of professional guidance and education outside a quarterly clinic visit. Individuals' perception of control, as a result of growing independent and competent self-management, is critical to achieve as it leads to personal responsibility and accountability for one's health outcomes. This is important to achieve with each individual/family given the tsunami of diabetes around the globe.

The present invention is an innovation against the background of the characteristics of practice in today's healthcare delivery systems. General practice elements that contribute to the current diabetes epidemic are lackluster attempts to achieve improvements and performance failures to effectively diagnose, treat and manage diabetes. These are notably: 1) retrospective analysis of cause of onset of illness or a chronic disease, 2) false memory (individual erroneously recalling and reporting past contributing events, 3) inconsistent, incomplete, uncoordinated care, 4) poor personalization of care due to lack of relevant, detailed individual information, 5) lack of systematic follow-up and monitoring of individuals' understanding of and adherence with recommendations and response to interventions thereby leaving outcomes to chance, 6) limited evidence-based medical care data, 7) incorrect diagnoses due to pressed time to listen to the individual/family resulting in inappropriate treatment causing increased, costly acute illness and step care, 8) wide variation in healthcare providers knowledge, experience and outcomes, and, 9) lack of transparency in care and outcomes.

To date only minimal improvements in patient self-management and health outcomes using current products/services have been reported in professional journals. Minimal improvements, however, lay the groundwork and point the direction to design, implement and scale significant improvements.

There are no products or technologies in the diabetes information and management market that provide comprehensive, in-depth, detailed and meaningful personalized information of an individual's daily management and outcome patterns with immediate analyzed information feedback in under a minute. Nor, do the episodic, retrospective, checklist formats of today's Electronic Medical and Personal Health Records weave a personal historical narrative or support prospective planning and management to achieve long-term personal best diabetes and health outcomes.

### SUMMARY OF THE INVENTION

The present invention joins the emerging paradigm shift focusing on individual/family oriented daily health management as distinct from today's acute illness and disease oriented healthcare systems. The present invention as a personal diabetes management program concentrates on a daily management routine of health habits, lifestyle choices and behaviors that either promote personal best diabetes and health outcomes or causes an individual to veer off course.

The present invention is based on a whole life context and approach. Daily diabetes management is embedded within one's usual daily living routine rather than fitting one's life into a rigid diabetes regimen. Central to the emerging paradigm shift is the method and process of real-time, systematic data/information reporting, tracking and monitoring designed to achieve evidence-based self-care and beneficial, long-term outcomes. Evidence-based self-care informs and guides anticipating and prospectively planning management to achieve long-term, best personal self-management strategies to become or remain healthy. The concept of health is always about the future; becoming or remaining healthy.

The importance of evidence-based population wide self-care and outcomes hold promise to inform and enhance evidence-based medical care.

The four core modules that make up the present invention are Settings, Glucose, Patterns and Training (TIPS). The modules begin a growing comprehensive system, of which the four modules are the critical management core, to integrate future modules offering expanding data/information to manage conditions associated with diabetes, e.g., depression, hyperlipidemia, hypertension, systemic complications, obesity, cancer and more, up to a potential of 25 additional management modules.

The goal of the present invention, as a personal diabetes management program, is to increase a perception of control, health literacy, confidence and independence in learning how to achieve competent self-management over a lifetime. This is important because diabetes is a progressive disease and usually a life-long condition that evolves through physiological and biological stages of growth/development and/or the aging process. Focus is on a daily living routine that encompasses right habits, lifestyle choices, behaviors and self-management strategies to make daily diabetes management easier to achieve personal best health outcomes.

One methodology for achieving the next-generation, personalized diabetes management invention is use of smart phones, e.g., iPhone, iPod/iTouch, Droid, etc. The mobile smart phone is held close to one's person and used as an extension of the hands and brain making it the best communication and information exchange tool to collect, analyze and produce immediate actionable information. Smart devices offer the platform for embedded intelligence in health information applications. It is expected that easier and better interpretation of personal information and health patterns leads to self-knowledge, understanding and more consistent application of knowledge to daily health and life management. Control over quality of life, productivity and energy through life stages and the aging process is advanced.

### BRIEF DESCRIPTION OF DRAWINGS

FIG. 1 is a graphic of one embodiment of the invention displayed on a smart device.

FIG. 2 is a block diagram of one embodiment of the invention, showing the interrelationship of the modules.

FIG. 3 is a flowchart of a method embodying the present invention.

FIG. 4 is a flowchart of a method embodying the present invention.

### DETAILED DESCRIPTION OF THE PREFERRED EMBODIMENT

The primary goal of the present invention is to support individuals/families to take control of daily diabetes management fitting into an overall daily living routine incorporating general health habits, choices and behaviors. Special focus is placed on developing the right habits, choices and behaviors that result in an individual's capability to competently manage to achieve personal best diabetes and health outcomes. The individual is his or her own standard for evaluating overall health status, progress or destabilization of health. Individual outcomes are also measured against established national standards of care and expected outcomes embedded in the application data collection and analysis processes to evaluate the narrowness or width of similarity or difference between individual outcomes and the standards of care.

The present invention design, methodology and value in the market uniquely and innovatively provides a real-time, streamlined process and system of data entry, analyses and immediate information feedback to prompt not only quick response/action to identified problems, outliers and adverse events in real-time but also documentation of the interrelationships among the daily core management elements; meals/snacks, activity/exercise and medication and their effect on blood glucose values. Innovative methods of analyzed data/information presentation in the Patterns Module makes interpretation easier to see the results of self-management; areas of good management and where changes need to be made to achieve personal best outcomes.

The present invention is designed to be used by people with all types of Diabetes; Types 1, 1.5, 2, Gestational, MODY (Maturity Onset of Diabetes in Youth) and LADA (Latent Autoimmune Diabetes in Adults). In addition to the initial four modules; Settings, Glucose, Patterns and Training (TIPS) Modules, future modules are planned to address specific needs of people with associated conditions that must be managed with diabetes to stay on course and enjoy a desired quality of life with the foundation of a stable health status. Individuals with diabetes, as a progressive disease, benefit from prospective planning and management to become or remain healthy tomorrow and into the future. The present invention offers individuals/families the hope and control of sustaining personal best health outcomes for their life span.

The design of the invention is mapped on the total daily activities required for competent self-management of diabetes. Specific focus is on the system and method for detecting daily living habits and choices that contribute to blood glucose outlier patterns that eventually lead to serious systemic complications. The App is specifically designed to capture high and low blood glucose patterns and associated information as to frequency, timeframes, symptoms, cause, treatment, results and response time to return to a prescribed blood glucose target range. The target range is personalized and can be set by the individual/family in the Settings Module. Each data point entered is time stamped.

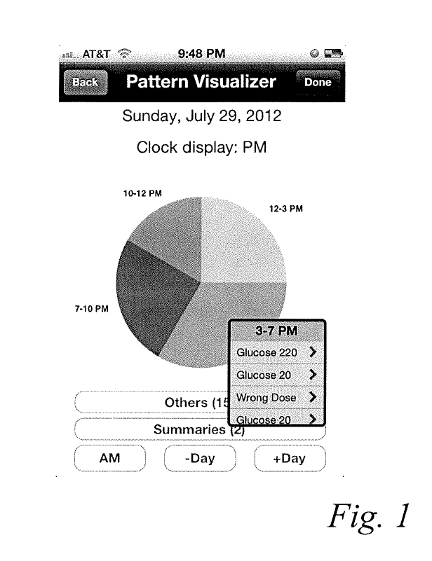

In one embodiment, shown in FIG. 1, the present invention streamlines and structures patient/family reporting on a smart device, e.g., smart phone, to collect data/information related to the three interrelated daily management activities, i.e., food intake, activities/exercise and medication to analyze their effect on blood glucose values. The product/service as a privately controlled, personal information application is designed to analyze and integrate blood glucose values with food intake, medications and exercise in multiples presentation formats including a 24 hour clock (12 hour AM and PM clocks) to demonstrate the results and response patterns of daily management. This information presentation of management results and patterns is a more familiar visual and understandable format than older methods of scatter grams, pie charts and bar graphs. The majority of individuals/families either can't or have difficulty interpreting and transferring information in scatter grams, pie charts and bar graphs to daily management planning, decisions and actions. The 24 hour clock method of data/information presentation is designed to empower and support the patient and family to see and more easily interpret, through immediate information analysis and feedback, personal health patterns, habits, lifestyle choices and behaviors that result in the quality of health outcomes.

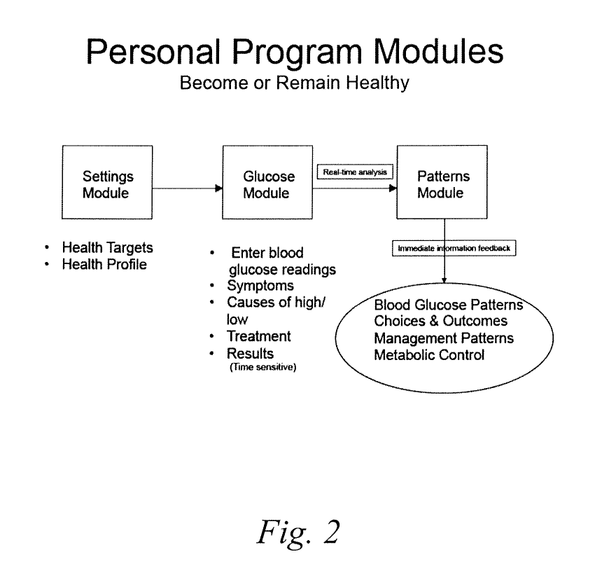

Refer to FIG. 2 for the following description.

The Settings Module contains historical baseline clinical data and demographics. The Glucose Module allows the individual/family to report blood glucose readings, e.g., normal, high, low and wide swings between high and low values including in-depth, detailed and meaningful data associated with the readings. Events associated with high, low or wide glucose swings are reported in the Glucose Module, specifically, the time of an event associated with an out-of-range glucose reading, the glucose reading(s), symptoms, possible causes, treatment, results and response time, i.e., the time it took to return to the prescribed blood glucose target range and achieve a stable health status. Examples of an event may be associated with intense exercise, too little exercise, sports, illness, infections, trauma, depression or psychological states such as depression. The application is designed to spot problems early and identify patterns that need evaluation for possible intervention and education to anticipate and prevent the same event from happening in the future. This is the anticipatory care function in the application. The anticipatory care function sets the stage for prospectively planning the future health pathway to achieve personal best health outcomes rather than leaving outcomes to chance.

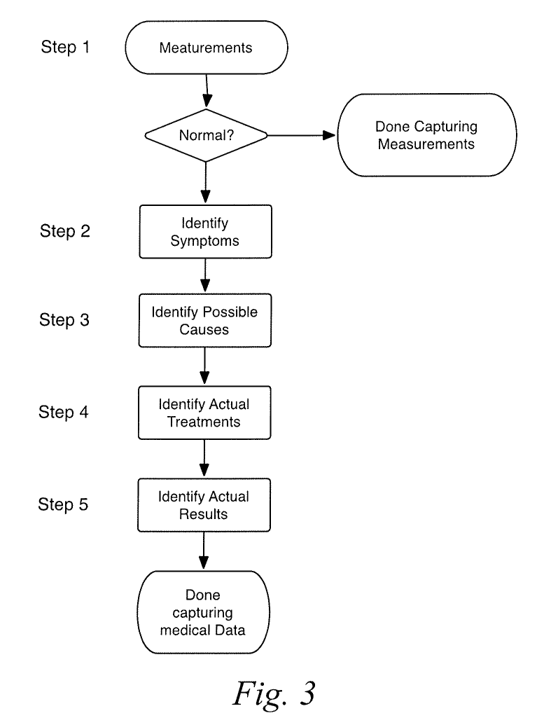

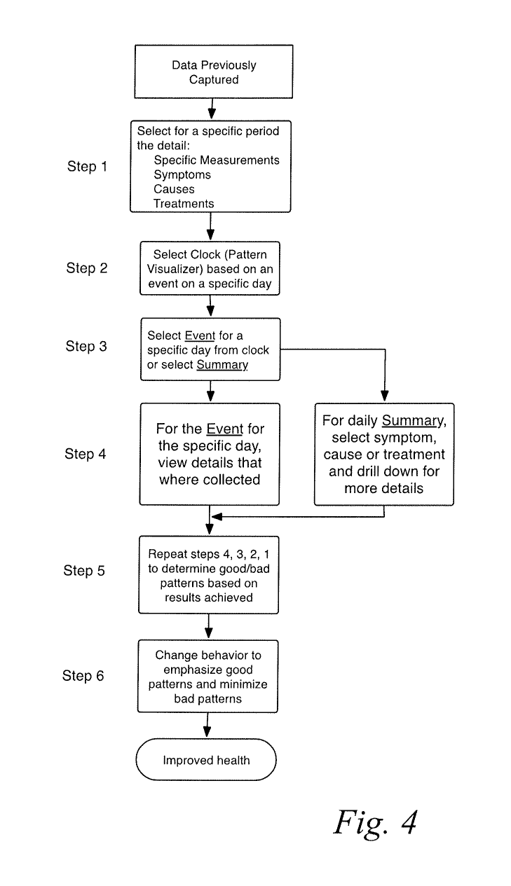

Refer to FIGS. 3 and 4 for the following description.

All data and information in the Settings and Glucose Modules are immediately analyzed and results sent to the Patterns module. Patterns result from analysis of frequent reporting of meals/snacks, activities/exercise and medications to reflect their relationship and effect on blood glucose values and metabolic control. The Training or TIPS Module explains how to use the Modules to assist in achieving competent management.

Detailed data is analyzed and presented in diverse presentation formats in the Patterns Module. Immediate information feedback is accessible upon reporting outliers, problems or an adverse event. The Patterns Module highlights the daily as well as aggregate outcomes resulting from ineffective habits, choices and behaviors. Interpretation of data/information is made easier through visualization of one's patterns in various ways. The individual/family can see when to seek help or where to adjust diet, exercise, medications or a daily routine as needed to achieve blood glucose target range and good metabolic control.

The Patterns Module provides several ways to view the data and corresponding patterns including a pie chart that reports the percentage of time one is in high, low or normal blood glucose levels. Also available is a vertical list of blood glucose readings, time stamped, with a timeframe (before/after meals, daily activities, exercise, medications, bedtime, during sleep and random). One can select to look at 10, 14 and 30 days of blood glucose readings. The eye can quickly scan and see blood glucose trends. An AM and PM clock provides a 24 hour detailed view of blood glucose levels, events, causes, symptoms, treatments and results in each marked time sector. The clock is designed to assist with easier interpretation of data and information the individual/family entered to reflect where best choices, habits and management are yielding the best outcomes and where improvements or changes may be needed to improve management and outcomes.

The four core management modules assist the user to better control and achieve competent daily self-management. More modules can be added depending on the information needs of individuals and families. An example is a module for depression and mental health, common to long-term diabetes management when individuals become tired of daily management. To relieve the fatigue and boredom with daily management, the present invention establishes, monitors and conducts long-term tracking of patterns and recommends, dependent on the individual's personal patterns, the frequency of reporting their daily self-management regimen to detect the need for changes in medication, diet or activity/exercise to obviate fatigue, stay on course and maintain overall health. The innovation and improvement over previous and existing products and services that are episodic, disease-oriented and from the medical perspective are: 1) systematic patient reporting, documenting, monitoring and tracking of the patient's long-term response patterns, 2) compliance with management protocols, 3) feedback in patterns on habits, lifestyle choices and behaviors, 4) prospective planning and management to become or remain healthy, 5) manage for personal best outcomes rather than leaving outcomes to chance, 6) educating via the training (TIPS) module to guide the user to learn at one's personal pace about diabetes and monitor diabetes as a progressive disease over time to make adjustments where needed to stay on course with prescribed target health goals.

Incentives to continue to use the present invention over the long term of living with diabetes can be added.

The present invention overcomes the limitations of current diagnosis, intervention and information/care methods and processes to quickly provide real-time, in-depth data entry and analysis requiring an average time of about 15 to 20 seconds for the experienced user. Entering normal blood glucose values takes about 3 seconds as there is no further data entry necessary. There are no systematic, long-term solutions in place today that account for the fact that diabetes is a progressive disease across the lifespan. Physiological and biological stages of growth, development and aging and their associated changes within the context of one's life with diabetes, require monitoring and on-time adjustments in management strategies to achieve an individual's best quality of life and prevent, delay, mitigate or reverse complications and co-morbid diseases.

Improvements in medications and blood glucose monitoring technologies have outstripped improvements in education and self-management. The present invention can improve the effectiveness of these tools with innovative design. The design of the present invention is based on the daily in-depth, detailed and meaningful management information needs of individuals/families to achieve prescribed blood glucose target goals and good metabolic control not possible by human effort alone. Most diabetes information products in the market are simplistic, many merely duplicating a paper log book in an electronic format and designed from a medical perspective, not an individual's perspective of daily living with diabetes. The present invention design creates a perception of control by the individual/family, important to achieve responsible and accountable self-care as many studies report since the 1970s. A perception of control is achieved through frequent data/information reporting, immediate analysis and information feedback to access outcome patterns in real-time. Outcomes patterns serve to visualize and more easily interpret the results of self-management; e.g., productive habits and lifestyle choices in addition to reflecting where changes are needed.

The value of the present invention is to enable an individual to become more independent through ongoing, on-time monitoring of progress or destabilization of one's diabetes and health status. A unique feature is providing education at the time one needs information to manage blood glucose outliers, problems or adverse events with prompts to guide quick response and return to a prescribed blood glucose target range. A benefit of frequent use of the application is to help establish a daily routine to make life easier, eliminating the need to constantly think through every management element. Lack of a daily routine may also lead to mindless management, i.e., inattention until one's becomes ill or experiences onset of complications of body systems.

Achieving gradually increasing knowledge and skills at one's personal pace at the point in time when needed and is “top of mind” promotes competent self-manage and replaces waiting to be told what to do between quarterly doctor visits when it is too late to accurately recall important details. That is: 1) learn to spot and identify outliers, problems or adverse events early, and, 2) reason through and act promptly to resolve outliers, problems or adverse events as a result of understanding and being able to correctly apply appropriate management protocols.

The reporting and data entry process in the present invention provides entering a timeframe of the blood glucose, e.g., before/after meals, daily activities, exercise, and medications. When outliers of high or low blood glucose values or wide swings between high and low values are identified, the associated in-depth reporting automatically goes to the appropriate pathway to enter symptoms, causes, treatment, results and response time, i.e., the time it took to return to a prescribed blood glucose target range. The normal, high and low pathways are color coded so that the individual knows he/she is entering data in the appropriate path. The time-stamped, detailed data/information reflects impact on diabetes and overall health outcome patterns across time. Patterns information is designed to provide several presentation formats to make personal interpretation of management and related outcomes easier, helping the individual/family to become more independent in decision-making and making relevant changes in daily management. Daily management becomes easier through forming a daily routine of the right habits, lifestyle choices and behaviors, all of which are confirmed or highlighted in patterns to see where success is achieved or changes, improvements or adjustments should be made.

The cumulative data/information is analyzed to reveal patterns to educate, guide and anticipate future health events based on habits, lifestyle choices and behaviors. In the case of problems, blood glucose outliers and adverse events, the individual is guided through a time stamped process of entering relevant data that integrates and analyzes total daily activities of meals/snacks, activity, exercise/sports and medications to reveal where errors or failures in management exist to competently coordinate these interrelated elements. The analyzed data is reflected in the Patterns Module to achieve pattern recognition that is used to prospectively manage for best personal outcomes in the future. The method and process in the present invention through data collection and immediate analyses produces personalized visual patterns in several different data presentation formats in the Patterns Module to address user preferences for reviewing and evaluating self-management, habits, lifestyle choices and behaviors. The method and processes are designed to reflect where good management is achieved as revealed by outcomes and where changes in habits, choices and behaviors are indicated.

Claim I

My Diabetes Success is a unique model for collecting data on smart phone/smart devices as well as any superset containing this model or a subset. Refer to FIG. 1.

Step 1 Take a measurement, for example, a Blood Glucose measurement

Step 2 Identify symptoms, for example, blurred vision

Step 3 Identify possible abnormal causes, for example, wrong dose

Step 4 Identify actual treatments, for example, Glucagon injection

Step 5 Identify actual results, for example, a blood glucose measurement closer to the normal range

Measurements, symptoms, causes, treatments, and results are called events, each being a type of event. A data point represents each event. A data point can consist of the type of event, date and time, timeframe (before breakfast, etc.), severity, medication, dosage, etc. Data points can be entered via keyboard, voice, camera (pictures/video) or from other disease related devices such as a glucose meter.

Customize personal and complete data collection in real-time from the individual/family using the smart phone/device technology. The individual/family reports by responding to a personalized as well as standardized question dataset, which allow free expression for data input where text, voice, camera or other devices can be used.

Claim II

Unique model for visualizing patterns, as well as any superset containing this model and any subset. Refer to FIG. 2.

Step 1 For a specific period (for example 10, 14, or 30 days), select measurements, symptoms, causes, and treatments, i.e., a type of Event. This produces a list of Events for the type of Event selected for the specific period.

Step 2 Select Clock (pattern visualizer) associated with an Event for a specific day from the list of Events. Refer to claim 6. A clock is displayed.

Step 3 Select an Event for a specific day from the Clock.

Step 4 For the Event for the specific day, view the data point that was collected.

Step 5 Repeat Steps 4, 3, 2, 1 to determine good/bad patterns relative to a target range of measurements.

Step 6 Change personal behaviors to emphasize good patterns and minimize bad patterns relative to the target range of measurements.

This results in a closed loop system, i.e., an initial series of measurement Events lead to a pattern that, in turn, leads to improvements which leads to another initial series of measurement Events.

Claim III

Tailoring the individual/family's real time perspective and insight into self-care through the data question sets, then immediately analyzing and providing integrated information feedback on the management of the interrelationships of meals/snacks, activity/exercise and medications and their effect on blood glucose values that reflect self-management knowledge, competence and results.

Educate patients/families in real-time with immediate information feedback to augment learning and the best self-management strategies that yield the best results at a personal pace over time; prompt and guide quick response and action to address and resolve health problems, adverse events or incorrect knowledge of management protocols to stay on course, i.e., obviate veering off course. This is designed to teach to anticipate and prevent future problems, adverse events or inaccurate application of management protocols by immediately reflecting results in the Patterns Module.

The events and associated data points are collected and passed on to the Pattern Analyzer where i above can be realized.

Claim IV

Ease of capturing relevant information increases motivation by offering valuable immediate information feedback in the Patterns Module. The time between collection and analysis is too long today. By systematically collecting and analyzing information in real-time, user motivation is increased to the point where data is timelier and more accurate. It is the interaction between the collection model and the pattern (analysis) model that provides support to this claim.

Claim V

Integrated pattern analysis of diabetes related biological and physiological parameters, health status, habits, lifestyle choices, behaviors, meals/snacks, activities/exercise and medications that impact blood glucose values and reflect metabolic control.

i. Tailored to the individual's manifestation of diabetes, personalized parameters and prescribed blood glucose target range.

ii. Nutritional data/information, report dietary intake (meals/snacks) by voice, text and camera when blood glucose values are high or low, outside one's prescribed target range.

Claim VI

Integration of time and clock charts by sector that deliver real-time data visualization. The clock charts are divided into sectors that enable the total data and results for each 24 hour period over 10, 14 and 30 days. Entire data sets, time stamped for each event associated with a timeframe (before/after meals, exercise, medications) and an outlier blood glucose value, including carbs, food intake, activity/exercise, medications causes, treatments, results and response time. The clock is designed to help the individual/family to detect patterns more easily.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. An evidence-based, personalized, diabetes self-care information system and method to better ensure improved personal management, outcomes and health status across time, comprising the steps of:
(a) Step 1 Take a measurement, for example, a Blood Glucose measurement;
(b) Step 2 Identify symptoms, for example, blurred vision;
(c) Step 3 Identify possible abnormal causes, for example, wrong dose;
(d) Step 4 Identify actual treatments, for example, Glucagon injection;
(e) Step 5 Identify actual results, for example, a blood glucose measurement closer to the normal range.

2. The information system and method of claim 1, further comprising measurements, symptoms, causes, treatments, and results called events, each being a type of event.

3. The information system and method of claim 2, further comprising a data point representing each event, a data point further comprising the type of event, date and time, timeframe (before breakfast, etc.), severity, medication, dosage, etc.

4. The information system and method of claim 3, wherein data points can be entered via keyboard, voice, camera (pictures/video) or from other disease related devices such as a glucose meter.

5. The information system and method of claim 1, further comprising customizing personal and complete data collection in real-time from the individual/family using a smart phone/device technology, and wherein the individual/family reports by responding to a personalized as well as standardized question dataset, which allow free expression for data input where text, voice, camera or other devices can be used.

6. An evidence-based, personalized, diabetes self-care information system and method to better ensure improved personal management, outcomes and health status across time, comprising the steps of:
(a) Step 1 For a specific period (for example 10, 14, or 30 days), select measurements, symptoms, causes, and treatments, i.e., a type of Event. This produces a list of Events for the type of Event selected for the specific period.
(b) Step 2 Select Clock (pattern visualizer) associated with an Event for a specific day from the list of Events. A clock is displayed.
(c) Step 3 Select an Event for a specific day from the Clock.
(d) Step 4 For the Event for the specific day, view the data point that was collected.
(e) Step 5 Repeat Steps 4, 3, 2, 1 to determine good/bad patterns relative to a target range of measurements.
(f) Step 6 Change personal behaviors to emphasize good patterns and minimize bad patterns relative to the target range of measurements.

7. An evidence-based, personalized, diabetes self-care information system and method to better ensure improved personal management, outcomes and health status across time, comprising the steps of:
(a) Tailoring the individual/family's real time perspective and insight into self-care through data question sets, then immediately analyzing and providing integrated information feedback on the management of the interrelationships of meals/snacks, activity/exercise and medications and their effect on blood glucose values that reflect self-management knowledge, competence and results;
(b) Educating patients/families in real-time with immediate information feedback to augment learning and the best self-management strategies that yield the best results at a personal pace over time; prompt and guide quick response and action to address and resolve health problems, adverse events or incorrect knowledge of management protocols to stay on course, i.e., obviate veering off course, designed to teach to anticipate and prevent future problems, adverse events or inaccurate application of management protocols by immediately reflecting results in the Patterns Module.

8. The information system and method of claim 7, wherein the events and associated data points are collected and passed on to a Pattern Analyzer.

9. An evidence-based, personalized, diabetes self-care information system and method to better ensure improved personal management, outcomes and health status across time, comprising an integrated pattern analysis of diabetes related biological and physiological parameters, health status, habits, lifestyle choices, behaviors, meals/snacks, activities/exercise and medications that impact blood glucose values and reflect metabolic control, the information system and method:
(a) being tailored to the individual's manifestation of diabetes, personalized parameters and prescribed blood glucose target range; and
(b) further comprising nutritional data/information, report dietary intake (meals/snacks) by voice, text and camera when blood glucose values are high or low, outside one's prescribed target range.

10. An evidence-based, personalized, diabetes self-care information system and method to better ensure improved personal management, outcomes and health status across time, comprising:
(a) integration of time and clock charts by sector that deliver real-time data visualization, wherein the clock charts are divided into sectors that enable the total data and results for each 24 hour period over 10, 14 and 30 days.

11. The information system and method of claim 10, further comprising entire data sets, time stamped for each event associated with a timeframe (before/after meals, exercise, medications) and an outlier blood glucose value, including carbs, food intake, activity/exercise, medications causes, treatments, results and response time, and wherein the clock is designed to help the individual/family to detect patterns more easily.
